(19) United States
(12) Patent Application Publication
(10) Pub. No.: US 2004/0017603 A1
(43) Pub. Date: Jan. 29, 2004

(54) Optical amplifier controller

(76) Inventors: Paul Jay, Stittsville (CA); Kenneth Mikolajek, Kanata (CA); Paul Dietz, Ottawa (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/206,121

(22) Filed: Jul. 29, 2002

(51) Int. Cl. H01S 3/00

(52) U.S. Cl. 359/341.4

(57) ABSTRACT

A method and system for controlling an optical amplifier in an optical waveguide system to reduce the effects of noise, particularly due to amplified spontaneous emission. The method comprises determining the gain between an input and an output of the optical amplifier; determining a customized pulse train in accordance with the determined gain and a desired gain; and controlling a pump source of the optical amplifier in accordance with the customized pulse train. Determining the customized pulse train includes determining a desired pulse width as a function of the determined gain, the desired gain and the pulse width at the determined gain. Similarly, a desired pulse spacing is determined as a function of the determined gain, the desired gain and the pulse spacing at the determined gain. Controlling the pump source preferably includes driving the pump source in accordance with the customized pulse train.

### FIELD OF THE INVENTION

The present invention relates generally to optical amplifiers. More particularly, the present invention relates to Rare Earth Doped Fiber Amplifier (REDFA) systems.

### BACKGROUND OF THE INVENTION

Optical amplifiers are an essential component of optical systems. Signal loss and attenuation of signal strength are important considerations in designing an optical system whether that system serves a communications, computing, medical technology function, etc.

Fiber optic technology is a well known optical technology and is used in a variety of communications networks. These networks often use long optical transmission lines, which are subject to attenuation of the optical signal. To compensate for this attenuated signal strength, optical amplifiers are used to boost the signal, thereby allowing long-haul transmission over greater distances. Optical amplifiers, such as REDFAs, are well known in the art. When the dopant ions in a fiber are energized to a condition of population inversion, the fiber will undergo emission in response to stimulation. In such a case the fiber acts as an amplifier. Such an amplifier will require a means for pumping (exciting) the dopant ions to the upper energy states, resulting in population inversion. The energy differential of the upper and lower energy bands of the fiber must correspond to the wavelengths of the optical input data in order to provide a corresponding gain band.

A typical REDFA consists of an optical fiber doped with a few parts per million of the rare earth element (for example, erbium), a continuous wave current-driven laser pump diode, an optical data input port, an optical data output port, and a port for introduction of the pump signal. When the laser pump injects high energy photons into the optical fiber, some erbium ions within the fiber are excited (pumped) from a base state to a higher-energy-state. The erbium ions stay in the said higher-energy-state for several milliseconds. The input data stimulates the excited erbium ions to return from their heightened energy state, to their base state, thereby emitting photons of the same wavelength as the input data.

Optical amplification is achieved when the number of photons emitted at a given wavelength exceeds (by several times) the number of input data photons at that same wavelength. For an Erbium Doped Fiber Amplifier (EDFA), this can occur at a number of wavelengths between 1530 nm and 1580 nm, known as “Conventional-Band or C-Band Amplification”. EDFAs can also be designed to provide amplification between 1580 nm and 1610 nm, which is known as “Long-Band or L-Band Amplification”.

A single erbium doped fiber may carry several communication channels, where each channel is assigned to a different wavelength. Since the gain of the fiber amplifier is a function of the relative population of the energy bands, adding or dropping a channel can result in a temporary change in population. When the number of channels fluctuates within the fiber amplifier (in cases where one or more channels are dropped or added), the gain of the amplifier system fluctuates over time, before reaching the new steady state. The effect of adaptation to this change is referred to as transient response. In this situation, the amplifier system gain has to be adjusted in such a way that a uniform gain (flat gain over time) is maintained. This is known as “transient suppression”. Transient suppression is a common technique for reducing or mitigating transients in the amplitude of the optical signal.

In an existing constant pump system, the driving current of the pump is a continuous wave. In cases where one or more channels are dropped, a constant gain is achieved by reducing the amplitude of the driving current of the pump laser diode. EDFA gain transients could result in fluctuations in optical data networks. Therefore, it is important to respond to the transients of EDFAs and reduce them. The transient suppression in the existing pump system is insufficient because the reaction time to transients is slow. This limitation confines the amplifier's ability to meet the system requirements, where gain must be regulated to maintain system performance.

The use of continuous wave pumps, if not optimized, can create an undesired overpopulation of excited dopant ions in the said higher-energy-band; the unused excited ions will spontaneously decay to their ground states, producing amplified spontaneous emission (ASE) at various wavelengths. This will appear at the output of the amplifier as optical noise degrading the quality of the desired amplified signal.

Another problem of traditional EDFAs is the overall power dissipated in the amplifier system as heat. System cooling and power requirements are important, especially for enclosed areas and remote applications. As integration density is increased, this power dissipation problem makes the implementation inefficient and costly.

It is known to modify the pump characteristics to create a signaling channel between stages. One approach uses non-continuous pumping to supervise any serious failure within the span and inform the receiving terminal of any failure when detected. The approach mentioned deliberately focuses on depletion of the reservoir of excited atoms, so as to impose an additional signal on the payload being amplified. The supervisory information is transferred by providing a distinct modulation frequency on the pumping source for each repeater stage. This was an improvement over the prior art's reliability of the optical transmission system by providing for communication of possible failure information without significantly disrupting the main signal. However, the supervisory modulation signal: does not directly contribute to any improvement in amplification efficiency; is focused on alarm detection rather than performance optimization; varies between stages rather than at a stage; and is non-responsive to gain.

Accordingly, there still exists a need for an optical amplifier that utilizes a laser pump whereby the pumping situation is optimized to reduce the power consumption and dissipation without degrading the performance (gain, noise level, etc.) of the amplifier system in conditions where continuous streams of high bit-rate digital pulses require amplification.

### SUMMARY OF THE INVENTION

It is an object of the present invention to obviate or mitigate at least one disadvantage of previous optical amplifier laser pumps. Accordingly, it is an object of the present invention to provide a laser pump used in an optical amplifier, whereby the power consumption and dissipation of the overall amplifier system is reduced.

In a first aspect, the present invention provides a method for controlling an optical amplifier in an optical waveguide system. The method comprises determining an operating characteristics at an input and an output of the optical amplifier; determining a customized pulse train in accordance with the determined characteristic and a desired characteristic; and controlling a pump source of the optical amplifier in accordance with the customized pulse train.

In presently preferred embodiments, the determined characteristic is the gain between the input and the output, or the output power. Determination of the gain includes splitting off optical input data and optical output data from the input and the output, respectively. Determining the customized pulse train can include determining a desired pulse width as a function of the determined characteristic, the desired characteristic and the pulse width at the determined characteristic. Similarly, a desired pulse spacing or amplitude can be determined as a function of the determined characteristic, the desired characteristic and the pulse spacing, or amplitude, at the determined characteristic. Controlling the pump source preferably includes driving the pump source in accordance with the customized pulse train.

In a further aspect, the present invention provides an optical amplifier control system. The control system comprises a gain controller for determining the gain between an input and an output of an optical amplifier, and for determining a customized pulse train in accordance with the determined gain and a desired gain. A driver, connected to the gain controller, receives the customized pulse train and drives a pump source of the optical amplifier in accordance with the customized pulse train. Preferably, a messaging unit enables remote communication with the gain controller.

In a further aspect, the above optical amplifier control system can be integrated with an optical waveguide amplifier and a pump source to provide an optical amplifier system.

Other aspects and features of the present invention will become apparent to those ordinarily skilled in the art upon review of the following description of specific embodiments of the invention in conjunction with the accompanying Figures.

### BRIEF DESCRIPTION OF THE DRAWINGS

Embodiments of the present invention will now be described, by way of example only, with reference to the attached Figures, wherein:

FIG. 1 is a block diagram of an erbium-doped fiber amplifier system of the present invention;

FIG. 2 is a graphical illustration of the pump driving current signal of the present invention;

FIG. 3 is a graphical illustration of the fiber input power;

FIG. 4 is a graphical illustration of the fiber output power uncorrected as per prior art;

FIG. 5 is a graphical illustration of a customized pulse train and average current of the present invention; and

FIG. 6 is a graphical illustration of the fiber input power vs. fiber output power corrected as per the present invention.

### DETAILED DESCRIPTION

A typical optical amplifier system of the present invention consists of an optical input data stream, a laser pump source and driver; control circuitry and sensors used for gain control. The input data coupled with the pump signal is applied to the optical amplifier waveguide (erbium-doped fiber in the preferred embodiment) to excite the (erbium) ions in the amplifier. A small percentage of the light is tapped from the input and output of the amplifier to measure the input and output power from the amplifier. This input and output power measurement is applied to the gain control circuitry to control the driver. The driver provides the driving current to the pump source whereby the corresponding pump power is applied to the waveguide to achieve optical amplification.

The invention takes advantage of the long time constant of the upper energy state of the rare-earth doping atoms in the embodiment. Pumping power is supplied discontinuously so that just sufficient excited atoms are available for amplification, but not so many that a significant number will decay spontaneously creating unwanted optical noise. This enables the user to reduce the power dissipation of an optical amplifier system by applying a pulsed drive current to the pump. With Pulse Width Modulation the power transistors operate within the most efficient points of operation: saturation and cutoff. Resistance within the switching transistors is either very high or very low, and the low on-resistance of MOSFETs helps to reduce the power consumed in the PWM supply for an equivalent amount of power supplied to the pump laser. By adjusting the drive current's pulse width and/or amplitude in response to the output of the gain controller circuit, a pump driver that requires minimum power is implemented without compromising the optimal output power of the pump signal that is applied to the optical amplifier waveguide. Other advantages and effects will become apparent in the ensuing description of the invention.

In addition to the power consumption/dissipation advantage of this invention, the present invention may make it possible to reduce the ASE. This affects the optimization of the signal to noise ratio of the amplifier system and as a result enhances the quality of the desired amplified signal.

Additionally, the present invention may substantially facilitate transient suppression. In the invention, the power output of the laser pump is pulsed in the duration where the gain response of the amplifier is non-uniform. This enhances the performance of the amplifier where the number of wavelength channels may fluctuate and enable transient signals to be reduced. In this manner the present invention may reduce saturation. Further, pulsed operation will reduce high temperatures and ameliorate ageing in some laser pumps.

The present invention is applicable to any situation where optical amplifiers can be used, such as: optical networks for long haul transcontinental, intercontinental & transoceanic (point-to-point) networks, Wide Area Networks (WAN), Metropolitan Area Networks (MAN), and Local Area Networks (LAN), biophotonics (including medical technology), printing technology, optical imaging, fiber sensor detection, optical computing, etc.

The invention will be described in more detail and in relation to the Figures and Drawings included in this disclosure. In the illustrated embodiments, an EDFA is used. However, those skilled in the art will appreciate that other types of optical amplifiers, rare earth doped or otherwise fabricated, and geometry's other than fiber (e.g. deposited or delineated waveguides) can be used while remaining within the scope of the invention.

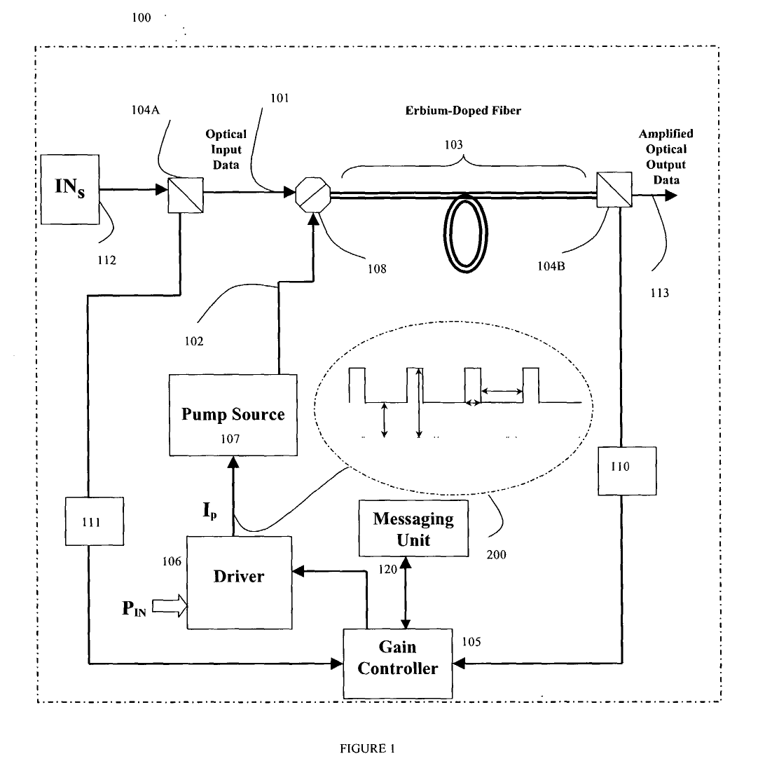

FIG. 1 is a block diagram of the preferred embodiment of the present invention showing an optical amplifier system. This diagram is a simplified representation and only includes the elements, which are necessary for the purpose of illustrating the invention.

The block diagram illustrates an EDFA system 100 of the present invention with input and output data splitters 104A and 104B respectively, a wavelength division multiplexer (isolator) 108, an erbium doped fiber 103, electro-optical transducers (photodiodes in this embodiment) 110 and 111, a controller 105, a current source, 106, and a pump source 107 used to pump the amplifier.

The optical input data path 101, the pump optical signal path 102, and the erbium-doped fiber 103 are connected to the combiner 108. The optical input data path 101 is also connected to the splitter 104A, along with the input source 112 and photodiode 111. The erbium-doped fiber 103 is connected to the splitter 104B along with photodiode 110 and the optical output data path 113. Both photodiodes 110 and 111 connect (electrically) to a controller 105. A current source 106 connects the controller 105 to the laser pump 107. The laser pump is the source of the pump optical signal path102.

A percentage of the light is tapped from the input source 112 of the amplifier by splitter 104A to measure the input power to the amplifier. The tapped light is received by the input monitor photodiode 111. Similarly, a small amount of light is tapped from the output of the amplifier by splitter 104B, to measure the output power from the amplifier. Light is tapped from the output of the amplifier and received by the output monitor photodiode 110. The tapped light received by the respective photodiodes 111 and 110 provides the respective input and output amplifier power measurements to the controller 105. The controller 105 is comprised of circuitry that generates the signal needed to regulate the current source 106 in response to the said input and output amplifier power measurements. Accordingly, the driver 106 generates the corresponding driving current signal (Ip) 200, applied to the pump source 107. The current signal 200 is a pulsing signal whereby the pulse rate, amplitude and offset are varied in response to the controller to provide the driving current to the pump source 107. The coupler 108 combines the input data path 101 with the pump light. The coupled signals are passed through the erbium doped fiber 103 to pump the erbium ions into population inversion and to concurrently induce stimulated emissions in the amplifier. The corresponding amplified optical output data is transmitted by the output path 113 coupled through the splitter 104B.

The advantages of the invention described are enhanced when there is capability to communicate remotely with the controller, allowing data to be collected from the controller or changes of pump conditions to be implemented in conjunction with other system needs. Apparatus for communicating these messaging signals will be obvious to those skilled in the art. Such apparatus is represented by the messaging unit,120, of FIG. 1.

A similar apparatus may incorporate additional pumps to better service the fiber on the basis of wavelength, polarization, or fiber connection location. Those skilled in the art will understand that such a similar system involving more than one pump falls within the scope of the invention.

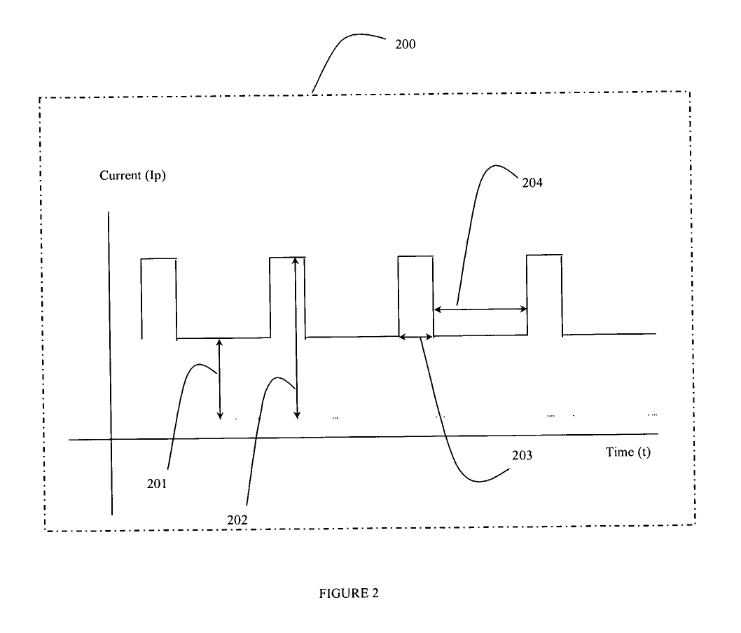

FIG. 2 is a detailed illustration of the pump driving current signal (Ip) 200 of driver 106 in FIG. 1 of the present invention. The pump driving current 200 is operated at an adjustable DC-offset current 201. The driving current's amplitude 202, and pulse rate (pulse width 203 and/or separation 204) are adjusted by the controller circuitry 105. The object is to minimize the electrical power required by the driver to efficiently provide the desired current to the pump source without altering the optimal output power of the pump signal that is applied to the EDFA.

By reducing the power consumed in the said current driver, the power consumption and dissipation of the overall amplifier system is reduced. The adjustment of pulse rate and amplitude differs from traditional methods, in which a continuous current is switched on and off to control system gain. It is not necessary for the pump drive pulses to be regularly spaced in time. Because of the characteristics of the Er energy levels in silica fiber, it is best if the time separation between drive pulses does not exceed the relaxation lifetime (˜ms) of the excited Er level.

In the present invention transients are reduced and power levels controlled by adjusting the amplitude 202 and pulse width (203) and separation (204) of the driving current. For example, in instances where rapid changes of gain are required within the erbium-doped fiber, the driving current can be optimized so as to maintain constant the gain over time within the amplifier system.

Ideally, the controller 105 would expand separation 204 in the case of higher gain than desired. Conversely, the controller 105 would compress the separation 204 in the case of lower gain than desired. Generally the separation may conform to the formula:

S=S₀+k(G−G_{d})

Where S is the separation 204, S₀ is the separation in the case of desired gain (G_{d}) and G is the gain detected by the controller 105. The coefficient k relates the severity of the response. Note that a system could incorporate maximum and minimum separation 204 without diverging from the essence of the invention. Similarly a minimum divergence on G may before observed before altering the separation.

Similar to the separation 204, the pulse-width 203 may be controlled. Generally the pulsewidth 203 will conform to:

P=P₀−m(G−G_{d})

Where P is the pulse-width 203, P₀ is the pulse-width in the case of desired gain (G_{d}) and G is the gain detected by the controller 105. The coefficient m relates the severity of the response. Note that a system could incorporate maximum and minimum separation 204 without diverging from the essence of the invention. Similarly, a minimum divergence on G may before observed before altering the separation. Either of the aforementioned adjustments may be used independently, together or in conjunction with a similar amplitude formula. This does not diverge from the scope of the invention. Those skilled in the art will understand simple variations may be made to the formulae above and still remain within the essence of the invention.

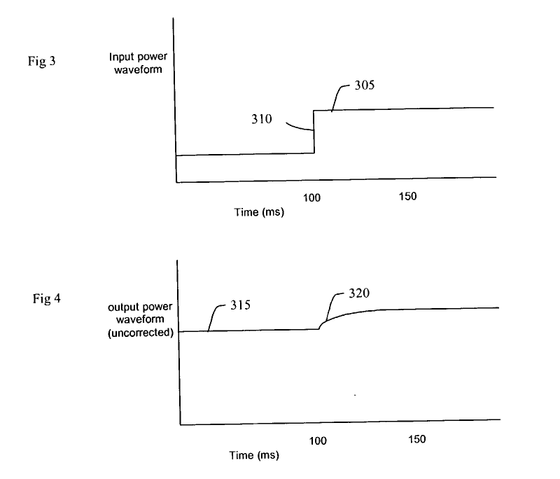

By virtue of the flexibility provided by the digital controller to alter pulse-width 203, separation 204, and amplitude 202, it is easy for those skilled in the art to program a customized pulse train for the drive current of the pump. Referring to FIG. 3, we see the input power 305 associated with a fiber that, for example, experienced an increase in the number of channels, and a corresponding increase 310 in input power 305. Referring to FIG. 4, the output power 315, responds latently 320 to the input power. This latent response results in low gain. Similarly in the case of dropping channels, temporarily high gain results. Referring to FIG. 6, a more responsive output power 325 is shown with respect to input power 305.

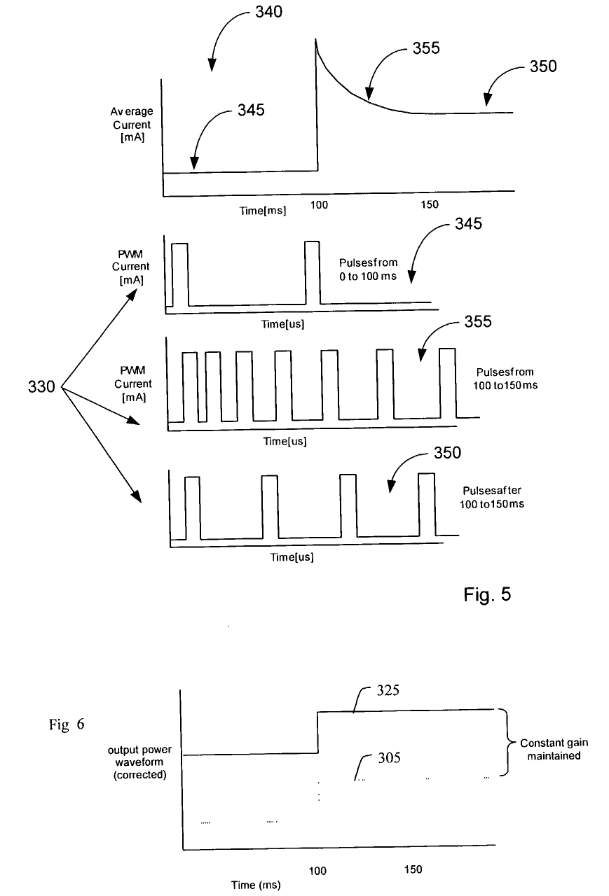

Referring to FIG. 5 we see a separation-varying customized pulse train 330, resulting in an average output current 340. This customized pulse train is shown for the channel-adding scenario described in FIGS. 3-5. The pulses arrive at an initial rate 345 corresponding to supplying a number of channels. The pulses arrive at a final rate 350 corresponding to supplying a final increased number of channels. During the transition 355 the pulse separation varies in a manner related to the discrepancy in gain as described above. In this case the separation alone is responsive, but similarly the pulse width 203 or amplitude 202 may be so, or some combination thereof.

This pulse train 330 will effectively pump the atoms in the fiber as required to generate the necessary output waveform from the amplifier, even in the face of abrupt changes at the input of the amplifier. In cases where a sudden decrease in current might be needed, the rate of pulses applied can be slowed down, or conversely accelerated when an increased current is needed. The delivery of this energy in pulsed form can provide power saving benefits, and also enables the pumping to be ideally adapted to the gain required, without excess pumping and associated noise generation.

The pump driving current 200 provides current to the pump source 107 efficiently, so as to avoid overpopulation of excited dopant ions in the higher-energy-band of the fiber. Therefore, reducing ASE (which is a result of unused excited ions in the said higher-energy-band) improves the signal to noise ratio of the amplifier system.

It should be further understood by those skilled in the art that certain variations and modifications can be made to this rare-earth-doped fiber amplifier system. For example, another waveguide geometry besides fiber may suffice, another rare earth dopant may be compatible, or another type of optical amplifier may be employed. It may be advantageous to incorporate these techniques with a fiber laser. None of these variations deviates from the original scope of the invention.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for controlling an optical amplifier in an optical waveguide system, comprising:
determining an operating characteristic at an input and an output of the optical amplifier;
determining a customized pulse train in accordance with the determined characteristic and a desired characteristic; and
controlling a pump source of the optical amplifier in accordance with the customized pulse train.

2. The method of claim 1, wherein the determined characteristic includes the gain between the input and the output, and the desired characteristic includes a desired gain.

3. The method of claim 2, wherein determining the gain includes splitting off optical input data and optical output data from the input and the output, respectively.

4. The method of claim 1, wherein determining the customized pulse train includes determining a pulse width.

5. The method of claim 4, wherein the pulse width at the desired gain is a function of the determined characteristic, the desired characteristic and the pulse width at the determined characteristic.

6. The method of claim 1, wherein determining the customized pulse train includes determining a pulse spacing.

7. The method of claim 6, wherein the pulse spacing is a function of the determined characteristic, the desired characteristic and the pulse spacing at the determined characteristic.

8. The method of claim 1, wherein determining the customized pulse train includes determining an amplitude.

9. The method of claim 8, wherein the pulse spacing is a function of the determined characteristic, the desired characteristic and the amplitude at the determined characteristic.

10. The method of claim 1, wherein controlling the pump source includes driving the pump source in accordance with the customized pulse train.

11. The method of claim 1, wherein the determined characteristic includes an output power, and the desired characteristic includes a desired output power.

12. An optical amplifier control system, comprising:
a gain controller for determining the gain between an input and an output of an optical amplifier, and for determining a customized pulse train in accordance with the determined gain and a desired gain;
a driver for receiving the customized pulse train and for driving a pump source of the optical amplifier in accordance with the customized pulse train.

13. The system of claim 12, further including a messaging unit for remote communication with the gain controller.

14. The system of claim 12, wherein the gain controller receives input optical data from an input splitter, and output optical data from an output splitter.

15. An optical amplifier system, comprising:
an optical waveguide amplifier;
a pump source for pumping the optical waveguide; and
a controller for controlling gain of the optical amplifier, the controller having a gain controller for determining the gain between an input and an output of the optical amplifier, and for determining a customized pulse train in accordance with the determined gain and a desired gain, and a driver for receiving the customized pulse train and for driving a pump source of the optical amplifier in accordance with the customized pulse train.

16. The optical amplifier system of claim 15, wherein the pump source is a current controlled pump source.

17. The optical amplifier system of claim 15, wherein the controller includes means for receiving input optical data from an input splitter connected to an input of the optical waveguide amplifier, and means for receiving output optical data from an output splitter connected to an output of the optical waveguide amplifier.
